(19) United States
(12) Patent Application Publication
(10) Pub. No.: US 2012/0201614 A1
(43) Pub. Date: Aug. 9, 2012

(54) METHOD AND APPARATUS IN A PNEUMATIC MATERIALS MOVING SYSTEM

(75) Inventor: Göran Sundholm, Tuusula (FI)

(73) Assignee: Maricap OY, Vantaa (FI)

(21) Appl. No.: 13/500,558

(22) PCT Filed: Oct. 1, 2010
(86) PCT No.: PCT/FI10/50758

§ 371 Date: Apr. 5, 2012

(30) Foreign Application Priority Data
Oct. 6, 2009 (FI) 20096027

(51) Int. Cl. B65F 5/00; B65G 53/24

(52) U.S. Cl. 406/168

(57) ABSTRACT

Method in a pneumatic materials moving system, having at least one input point with a material transfer pipe connected to an input point. At least one separating device, in which the material to be conveyed is separated from the conveying air. A pressure difference and/or a conveying air current in the transfer pipe. At least during conveyance of the material with at least one pump unit at least one transfer pipe section in which conveying air is circulated and at least one transfer pipe section in which conveying air is not circulated. The conveying route of the material in the transfer piping is formed partly from the transfer pipe section in which conveying air is not circulated and partly from the transfer pipe section in which conveying air is circulated.

### BACKGROUND OF THE INVENTION

The object of the invention is a method as defined in the preamble of claim 1.

The object of the invention is also an apparatus as defined in the preamble of claim 15.

The invention relates generally to pneumatic materials moving systems, such as partial-vacuum conveying systems, more particularly to the collection and moving of wastes, such as to the moving of household wastes.

Systems wherein wastes are moved in piping by means of suction are known in the art. In these, wastes are moved long distances in the piping by sucking. The apparatuses are used for, among other things, the transfer of wastes in different institutions or for the transfer of household waste in urban areas. It is typical to these systems that a partial-vacuum apparatus is used to bring about a pressure difference, in which apparatus a partial vacuum is achieved in the transfer pipe with partial-vacuum generators, such as with vacuum pumps or with an ejector apparatus. A transfer pipe typically comprises at least one valve means, by opening and closing which the replacement air coming into the transfer pipe is regulated. In partial-vacuum transfer systems there are typically the following problems, among others: high energy consumption, high air flow in the piping, problems with noise, and dust and fine particle problems in the outlet pipe. In addition, especially with large distances, in which the lengths of a transfer pipe can be several thousands of meters, the pressure loss increases, in which case in order to ensure satisfactory operation of the transfer system very large pipe diameters and correspondingly efficient pump devices, i.e. fans are needed. This results in very expensive solutions in terms of costs, and also as the pipe size increases more space is required for the installations.

It has been possible to considerably improve prior-art solutions by producing a system, in which at least a part of the transfer piping can be connected as a part of a circuit, in which conveying air is circulated, at least during the conveyance of the material, with a pump device the suction side of which is connected to at least one separating device and further to a transfer pipe on its return side so that at least a part of the conveying air on the pressure side of the pump is led into the circuit on the output side of the transfer pipe. This type of solution is presented in e.g. patent publication FI 20085141 and in the corresponding patent publication WO2009/080881.

The aim of the present invention is to further develop the aforementioned systems and to achieve a totally novel solution in connection with the transfer systems of a material, by means of which solution the drawbacks of prior-art solutions will be avoided. Another aim of the invention is to achieve a solution applicable to partial-vacuum transfer systems that is suited to large systems. Yet another aim is to achieve a solution, by means of which the volume of outlet air of the system and, at the same time, emissions of dust and fine particles and possible odor nuisances can be decreased.

### BRIEF DESCRIPTION OF THE INVENTION

The method according to the invention is mainly characterized by what is disclosed in the characterization part of claim 1.

The method according to the invention is also characterized by what is stated in claims 2-14.

The apparatus according to the invention is mainly characterized by what is disclosed in the characterization part of claim 15.

The apparatus according to the invention is also characterized by what is stated in claims 16-28.

The solution according to the invention has a number of significant advantages. By arranging at least a part of the piping in a circuit, in which the conveying air can be circulated, an effective conveying effect is achieved in the different parts of the transfer piping and also a fast transfer from the input pipe to the transfer pipe is achieved. By arranging the piping of the system to comprise a circuit where at least a part of the conveying air circulates, the volume of outlet air can be decreased. At the same time the energy consumption of the system decreases. By maintaining a partial vacuum and, at the same time, blowing an effective circulation of conveying air can be achieved in the circuit and conveying of material in the transfer pipe. With the solution according to the invention a conventional so-called “Single Line” system that comprises one transfer pipe can be efficiently combined with a solution in which at least a part of the transfer piping forms a circuit in which conveying air can be circulated, i.e. a Ring Line system. At the same time total energy consumption can be made more efficient when at least a part of the conveying distance is performed in the transfer piping in which conveying air is circulated. This is a significant advantage, particularly in large waste-conveying systems that cover e.g. a whole city district or city. The invention enables the use of smaller pipe diameters of the transfer piping in pipe sections that are connected at their second end to the transfer piping that forms a circuit but in which sections conveying air is not circulated, i.e. to a so-called “Single Line” section. When using a system according to the embodiment of the invention, in which a system that utilizes the circulation of conveying air, i.e. a Ring Line system, and a transfer pipe section, in which conveying air is not circulated, i.e. a Single Line system, connected to it are combined, an advantageous pressure loss situation is achieved.

When the Single Line and the Ring Line systems are connected, the Single Line pipe section can be selected to be smaller and the diameter of the Ring Line pipe section, i.e. the pipe section in which conveying air can be circulated in the circuit, to be larger, if necessary. In this case some of the air volume is sufficient to transfer wastes in the Single Line part of the piping to the Ring Line pipe section, i.e. to the pipe section that forms a circuit, in which conveying air can be circulated. The total power requirement decreases, in which case a considerable saving is achieved. Typically the saving is in the range of 30-50%. With the solution according to the invention, it is possible to essentially reduce the volume of outlet air and at the same time to reduce possible dust problems and fine particle problems in the outlet pipe. Furthermore, the odor nuisances of transfer pipings typical to conventional pneumatic conveying systems of wastes can be reduced. According to the invention at least a part of the transfer piping can be connected as a part of a circuit in which the suction effect to be achieved with the pump devices can be adjusted and/or controlled and/or opened or closed with closing means/adjustment means, such as valve means, which are arranged in connection with the transfer piping. In this case suction can be efficiently circulated in the system even if the transfer piping of the system would not be a complete ring. At the same time efficient conveying of material can be achieved in the piping. With the method and apparatus according to the invention it is possible to efficiently adjust the relationship of the air to be blown into the transfer piping and the air to be blown out of the system. With the solution according to the invention, the noise problem caused by prior art can also be essentially reduced. Moisture accumulated in the piping decreases and the piping can be dried by circulating air in the piping. When the air to be sucked in decreases, the use of energy also decreases. By opening and closing the input points of the system according to the invention, efficient transferring of material into the transfer pipe and conveying in the transfer pipe is achieved, while at the same time it is possible to keep the noise impact caused by the operation of the system small. By arranging the transfer pipe of the materials moving system to be composed of operating areas, i.e. subcircuits, the conveying of material in the transfer piping and the emptying of input points into the transfer pipe can be effectively arranged. By arranging the conveying air circulation in the opposite direction an effective removal of clogging can be achieved. The change of the conveying air circulation into the other direction can be arranged easily in ring piping. Also the total energy consumption decreases because, among other things, additional energy for drying the piping, heating the piping, etc., is not needed.

### BRIEF DESCRIPTION OF THE FIGURES

In the following, the invention will be described in more detail by the aid of an example with reference to the attached drawing, wherein

FIG. 1 presents one system according to the embodiment of the invention as a diagram, in a first operating phase,

FIG. 2 presents one system according to the embodiment of the invention as a diagram, in a second operating phase,

FIG. 3 presents the situation of FIG. 2 clarified with some of the components of diagram 2 removed,

FIG. 3a presents a detail of the system, and

FIG. 4 presents a simplified diagram of a system according to the embodiment of the invention.

### DETAILED DESCRIPTION OF THE INVENTION

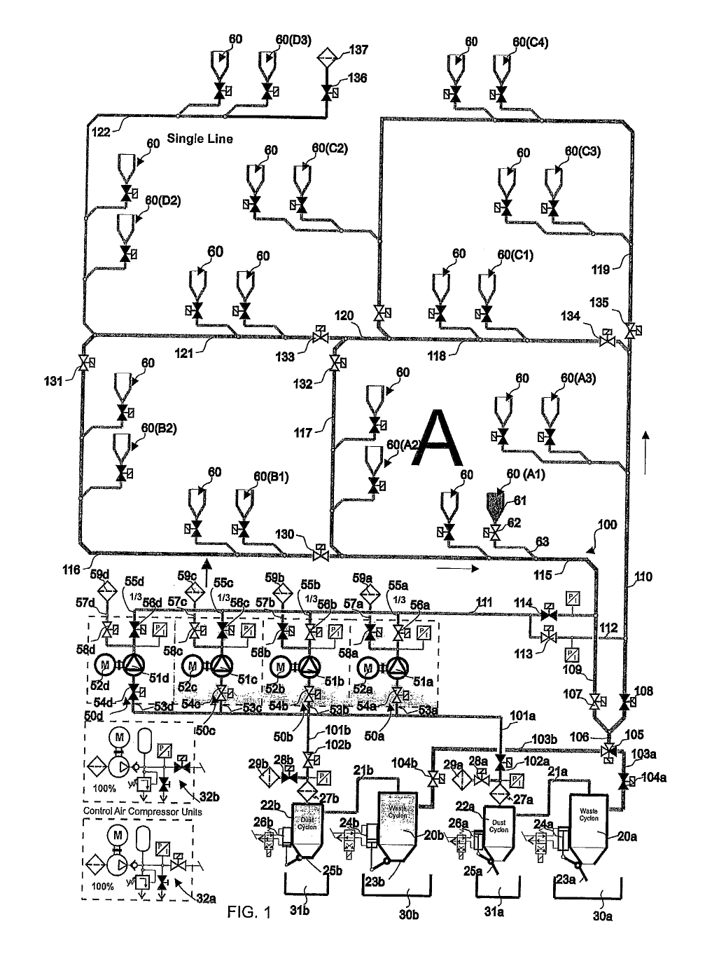

FIGS. 1-3 present as a simplified diagram a pneumatic materials moving system, more particularly a wastes transfer system, according to one embodiment of the invention. The figure presents a material transfer pipe 100, which is formed from a number of sections 106, 109, 110, 115, 116, 117, 118, 119, 120, 121, 122, along the side of which transfer pipe at least one, typically many, input points 60 are arranged. The input point 60 is a feed-in station of material, more particularly of waste material, intended to be conveyed, from which station the material, more particularly waste material, such as household waste, intended to be conveyed is fed into the transfer system. The system can comprise a number of feed-in stations 60, from which the material intended to be conveyed is fed into the transfer piping. In the figures the input point components are described with reference numbers in connection with only one input point 60. The input point 60 typically comprises a feed-in container 61, which can be connected to an input pipe 63. A transfer pipe typically comprises at least one valve means 62, by opening and closing which material can be transferred from the input point into the transfer pipe. The input pipe 63 is connected to the transfer pipe 100, which can thus be formed from a number of pipe sections 106, 109, 110, 115, 116, 117, 118, 119, 120, 121, 122. The input pipe 63 can comprise a number of input points 60, which are connected to a transfer pipe via one input pipe.

The replacement air needed in emptying the feed-in container 61 comes, in the embodiment of FIG. 1, via the feed-in container 61. According to a second embodiment, a separate replacement air branch coupling, which can be provided with a filtering means, can additionally be in connection with an input point.

The material fed into the transfer pipe 100 from the input point 60 is conveyed along the transfer piping to one or more separating devices 20a, 20b in which the material being conveyed is separated, e.g. due to the dropping of speed and centrifugal force, from the conveying air. The separated material is removed, e.g. according to need, from the separating device 20a, 20b, to a material container 30a, 30b, such as a waste container, or to further treatment. The material container can comprise a waste compactor (not shown), with which the material is compacted by compressing into smaller size and from which compactor the material is further conveyed to the waste container.

In the embodiment of FIG. 1, two separating devices 20a, 20b are presented, into which material can be transferred in a controlled manner. In this case when e.g. the first separating device 20a is filled the material to be transferred can be guided to a second separating device 20b. A corresponding arrangement can be applied e.g. when sorting the material to be transferred into different allotments. In the embodiment of the figures both separating devices 20a, 20b are provided with material removing means 23a, 24a; 23b, 24b. The material removing means comprise e.g. a closing means 23a, 23b of the output aperture and the drive means 24a, 24b of it. From the separating device 20a, 20b the pathway 21a, 21b of the medium leads to the particle separator 22a, 22b and further a conveying air duct 101a, 101b to the means 50a, 50b, 50c, 50d for forming a partial vacuum in the transfer pipe.

In the embodiment of FIG. 1 the means for forming a partial vacuum comprise a number of pump units 50a, 50b, 50c, 50d. By means of them the partial vacuum needed in conveying material is produced in the transfer piping and/or in a part of it. Each of the pump units 50a, 50b, 50c, 50d comprises a pump device 51a, 51b, 51c, 51d, which is used with a drive device 52a, 52b, 52c, 52d. The suction side of the pump devices can be connected via the separating means 20a, 20b to the transfer piping 100. The blowing side of the pump devices 51a, 51b, 51c, 51d, for its part, can be connected in the embodiment of the figure to blow into the transfer pipe 100 via the line 111 and/or into the outlet line 57a, 57b, 57c, 57d. The diagram according to the figures presents four pump units 50a, 50b, 50c and 50d. The operation of the invention is described in the following, however, by means of only three pump units 50a, 50b, 50c, in which case the fourth pump unit 50d is e.g. in reserve.

The blowing side of the pump device 51a of the first pump unit 50a has two lines, a line 55a leading to the transfer piping 100 and an outlet line 57b, which lines are provided with the valve means 56a and 57b. In the embodiment of the figure, the outlet line is provided with a filtering means 59a. The blowing produced by the pump device of the pump unit can be controlled by opening and closing the valves 56a and 57a. The suction side of the pump device 51a of the pump unit is connected with a suction line 53a to the line 101a or 101b going to the separating device 20a, 20b. The suction line comprises a valve means 54a. The second pump unit 50b, third pump unit 50c and fourth pump unit 50d have corresponding components and functions to the first pump unit. In addition, each pump unit is provided with a pressure sensor P/I, which in the embodiment of the figure is connected to the blowing side of the pump device.

The system thus comprises means for leading the outlet air of the pump devices into at least a part of the transfer piping. The transfer piping 100 in the embodiments of the figures can be divided into operating areas or subcircuits A, B, C, D with the valve means 107, 108, 130, 131, 132, 133, 134, 135, i.e. with area valves.

At least a part of the transfer piping 100 can be connected as a part of a circuit, in which conveying air can be circulated with a pump device, the suction side of which is connected to at least one separating device and onward to a transfer pipe on its return side, such that at least a part of the conveying air on the pressure side of the pump device is led into the circuit on the output side of the transfer pipe. In the embodiment according to the figure at least a part of the transfer piping can be formed as a ring or as a number of rings, in which the conveying air circulation can be changed by means of valve means.

In the embodiment according to the figures, it is assumed for the sake of clarity that each of the pump units 50a, 50b, 50c delivers into the transfer piping approx. ⅓ of the suction, partial vacuum or air flow produced by the apparatus and correspondingly approx. ⅓ of the air flow on the blowing side or of the pressure on the blowing side, if they are connected to a transfer pipe.

According to a second embodiment it is possible that the output power of the pump devices can be adjusted, in which case the suction powers/blowing powers achieved with the different pump devices can be varied according to need.

FIG. 1 presents a situation in which the input point 60 (A1) of subcircuit A is being emptied, the feed-in container 61 of which input point is darkened in FIG. 1. The suction sides (suction lines 53a, 53b, 53c) of each of the three pump devices 50a, 50b, 50c are connected to the line 101b and onwards via the particle separator 22b and the line 21b and also the separating device 20b to the return end 103b of the transfer pipe. In this case the waste material is thus transferred from the input point 60 along the transfer pipe to the second separating device 20b. The valve means 105, which in the embodiment of the figures is a three-way valve, conducts the suction effect produced by the pump devices onwards to the transfer pipe section 109, when the valve means 107 is open. The transfer pipe section 109 connects to a second transfer pipe section 115, to which the input pipe 63 of the input point 60 to be emptied connects. When traveling against the flow direction of the waste material, the input point in question is closest to the separating means 20b, i.e. to the delivery end of the waste material. In the situation of FIG. 1 the area valves 130, 131, 132, 133, 134 and 135 are open and the valves of the input pipe of an input point other than that to be emptied are closed (black in the figures).

The transfer piping of the figure also comprises one individual pipe branch, i.e. the pipe section 122 in the figure, the free end of which comprises a replacement air valve 136 and a filtering means 137, from which free end the pipe branch is not connected to any other transfer pipe section. The replacement air valve 136 in question is also closed in the situation of FIG. 1.

In the situation of FIG. 1 the blowing sides of the pump devices 51a, 51b of two pump units 50a and 50b are connected to blow into the transfer piping via the lines 55a, 55b and the pipes 111 and 112 into the output side of the transfer pipe in the pipe section 110. Since the suction side of the pump devices of three pump units are connected to the transfer piping and the blowing sides of only two pump units to the transfer piping on the output side, the piping contains a partial vacuum at least on the return side of the piping.

At least a part of the transfer piping 100 is used as a reservoir, into which the pressure side and/or the suction side of at least one pump device 51a, 51b, 51c, 51d can be connected such that the suction effect achieved in the transfer piping is greater than the blowing effect.

The return side of blowing is fitted to be with respect to the input pipe of the input point to be emptied on the side in the transfer pipe that is away from the separating device. In this case e.g. approx. ⅔ of the air flow in the transfer pipe at the point of the input pipe 63 comes from the blowing of the pump devices 51a, 51b and e.g. approx. ⅓ via the replacement air branch coupling and/or the feed-in container 61, when the losses and possible leaks of the system are not taken into account.

In the case according to FIG. 1, when in the input point 60 (A1) the valve means 62 of the point is opened, the material batch intended to be transferred is transferred into the transfer pipe from the input pipe 63 into the section 115 of the transfer pipe for transferring onwards along the route 115-109-106-103b to the separating device 20b. Possible replacement air into the transfer pipe comes e.g. via the feed-in container 61 of the input point 60(A1) and/or from the replacement air branch coupling into the transfer pipe when the valve 62 is opened. The blowing side of one pump unit is thus in the operating mode in question in the embodiment of the figure arranged to blow into the outlet duct 57c, in which typically at least one filter device 59c is arranged, as in the embodiment of the figure, to filter the outlet air. A valve means 58c is arranged in the outlet duct 57c. In the figure a connection, such as via the air ducts 111, 112, is arranged from the blowing side of two pump devices 51a, 51b to the transfer pipe 110 on the output side of it. A valve means 114 is arranged in the air duct 111 on the blowing side, which valve means when closed prevents a connection of the blowing side to the pipe section 109 of the transfer pipe, which in the embodiment and the operating mode of the figure is the return side. The apparatus according to the embodiment of the figures comprises means 111, 112, 113, 114, by means of which the blowing side of the pump devices can be connected to blow into the circuit of the transfer piping at least in two directions that are opposite to each other.

The blowing in the transfer piping is led in the piping such that at the point at which the input pipe 63 of the input point to be emptied is connected to the transfer pipe, a flow according to the transfer direction of the material prevails at least during the emptying.

In the following an operating mode of the system according to the invention is described, in which operating mode one of the two feed-in containers 60(A2) of an input point of the area A is emptied into the transfer pipe. Now the section of transfer pipe in question is the pipe section 117 that is in the center of the more extensive circuit. The valve 130 of the transfer pipe is now closed with respect to the situation of FIG. 1, by means of which valve the suction effect of all three pump devices can be directed at exactly the correct pipe section, on the one hand, and at the same time it is ensured that the flow is not able to occur past the pipe section 117 in question, e.g. via the pipe section 116. The contents of the feed-in container of the input point 60 (A2) transfer via the input pipe to the pipe section 117 of the transfer pipe and onwards along the route 115-106-103b to the separating means 20b.

Correspondingly when it is desired to empty the feed-in container of the input point 60(A3), the input pipe of which is connected to the transfer pipe to the section 110, which in the previous figures was the pipe section to which the blowing side of the pump devices was connected. The blowing air is now controlled by means of the valves 113 and 114 to circulate in the piping in the opposite direction. The pipe section 111 of the blowing side of the pump devices is now directly connected to the pipe section 115, which is now the output side. In addition, the valve 107 of the transfer pipe is closed, in which case there is no direct connection from the pipe section 109 to the pipe section 103b leading to the separating means. Correspondingly the valve 108 is opened, in which case there is a connection to the separating means via the pipe section 103b from the pipe section 110, which is now the return side. The valve 130 that was closed in the previous operating mode is opened. The contents of the feed-in container of the input point 60 (A3) transfer to the pipe section 110 of the transfer pipe and from there onwards via the pipe section 106-103b to the separating means 20b.

In the following the operating mode in which the feed-in container of the input point 60(C1) is emptied is described. Compared to the previous operating mode, the valves of the input point 60(C1) now to be emptied have been opened, and the valves of the input point 60(A3) that were open in connection with the previous emptying are closed. In addition, the valve 135 of the transfer pipe, which is between the pipe sections 119 and 110, is closed. In this case the suction effect of all three pump devices can be directed at exactly the correct pipe section 118, on the one hand, and at the same time it is ensured that the flow is not able to occur past the pipe section 118 in question, e.g. via the pipe section 119. The contents of the feed-in container of the input point 60(C1) transfer to the pipe section 118 of the transfer pipe and from there onwards via the pipe section 110-106-103b to the separating means 20b.

Correspondingly when the next feed-in container 60(C2) of an input point of the area C is emptied. Compared to the previous operating mode, the valves of the input point 60(C2) to be emptied have been opened, and the valves of the input point that were open in connection with the emptying of the previous figure are closed. In addition, the valve 135 of the transfer pipe, which is between the pipe sections 119 and 110, is further closed. Also the valve 133 of the transfer pipe is closed. In this case the suction effect of all three pump devices can be directed at exactly the correct pipe section 119, on the one hand, and at the same time it is ensured that the flow is not able to occur past the pipe section 119 in question. The contents of the feed-in container transfer to the pipe section 119 of the transfer pipe and from there onwards via the pipe section 118-110-106-103b to the separating means 20b.

Next the feed-in container of the next input point of the area C is emptied. Compared to the previous operating mode, the discharge valve of the input point 60(C3) to be emptied has been opened, and the discharge valve of the input point 60(C2) that was open in connection with the emptying of the previous figure is closed. In addition, the valve 135 of the transfer pipe, which is between the pipe sections 119 and 110, is now opened. On the other hand, the valve 134 between the pipe sections 110 and 118 is closed. In this case the suction effect of all three pump devices can be directed at exactly the correct pipe section 119, on the one hand, and at the same time it is ensured that the flow is not able to occur past the pipe section 119 in question, via the pipe section 118. The contents of the feed-in container of the input point 60(C3) transfer to the pipe section 119 of the transfer pipe and from there onwards via the pipe section 110-106-103b to the separating means 20b.

Next the feed-in container 60 of the next input point 60(C4) of the area C is emptied the same route as in the situation described earlier. Compared to the previous operating mode, the discharge valve of the input point 60(C4) to be emptied has been opened, and the valve of the input point 60(C3) that was open in connection with the emptying of the previous figure is closed. In other respects the valves are in the position of the preceding operating mode. The contents of the feed-in container of the input point 60(C4) transfer to the pipe section 119 of the transfer pipe and from there onwards via the pipe sections 110-106-103b to the separating means 20b.

When it is desired to next empty the feed-in container of the input point 60(B1) of the area B, the discharge valve of which has been opened, and the discharge valve of the input point 60(C4) that was open in connection with the emptying of the previous figure is closed. The suction sides of the pump devices are connected to act on the pipe section 109 by opening the valve 107 in it and by closing the valve 108 of the pipe section 110. Correspondingly, the blowing sides of the pump devices 51a, 51b are connected to the pipe section 110 by opening the valve 113 of the duct 112 and by closing the valve 114 between the pipe section 109 and the air duct 111. Also the valve 132 in the pipe section 117 is closed. The contents of the feed-in container of the input point 60(B1) of the area B transfer to the pipe section 116 of the transfer pipe 100 and from there onwards via the pipe sections 115-109-106-103b to the separating means 20b.

Next the feed-in container of the next input point 60(B2) of the area B is emptied the same route as in the situation described earlier. Compared to the previous operating mode, the valve of the input point 60(B2) to be emptied has been opened, and the discharge valve of the input point that was open in connection with the emptying of the previous input point 60(B1) is closed. In other respects the valves are in the positions of the preceding operating mode. The contents of the feed-in container of the input point 60(B2) of the area B transfer to the pipe section 116 of the transfer pipe 100 and from there onwards via the pipe sections 115-109-106-103b to the separating means 20b.

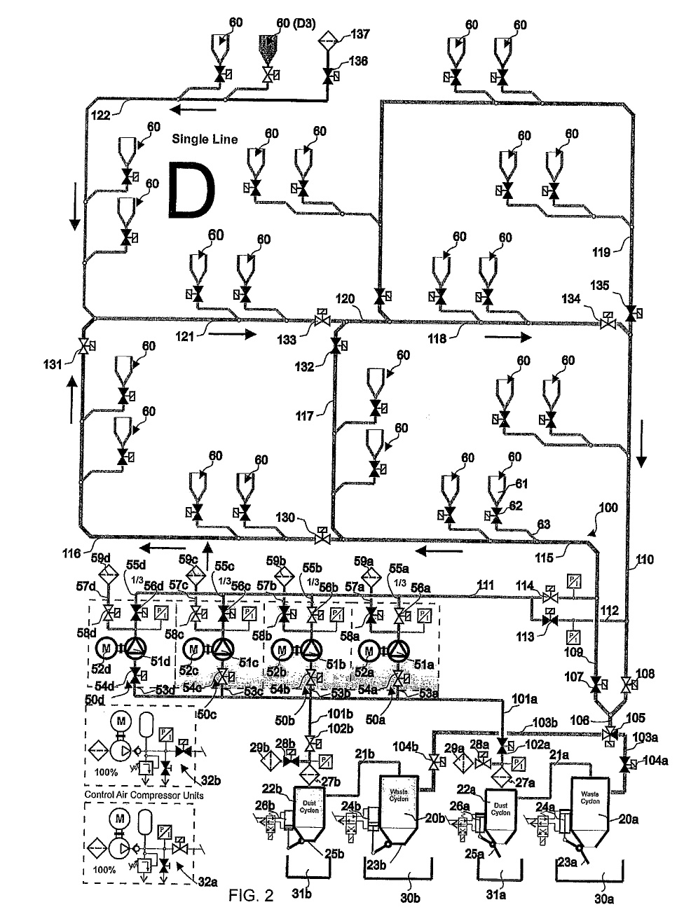

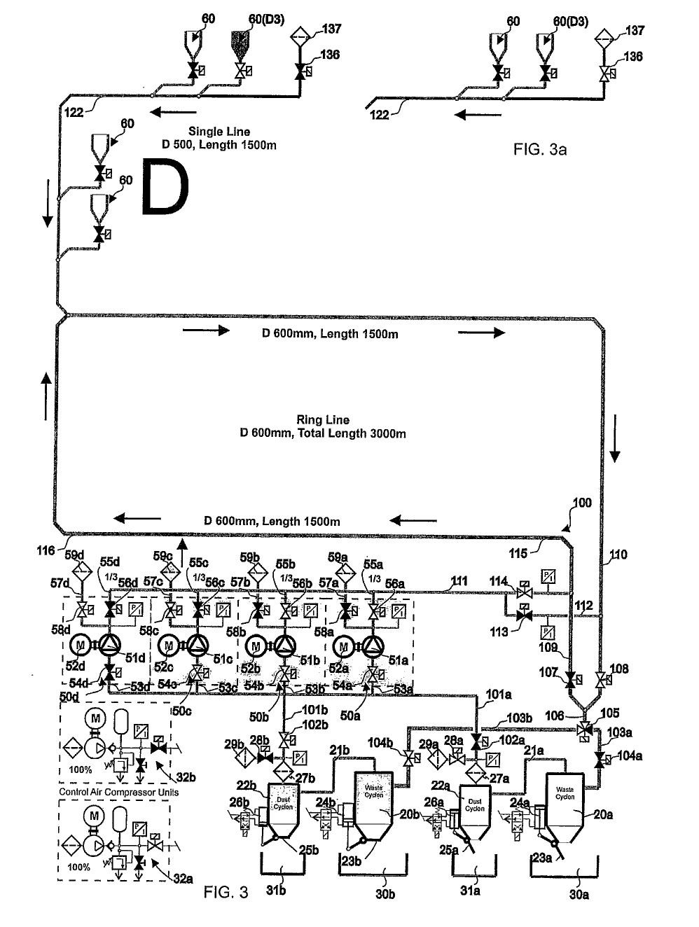

Next the feed-in container of the input point 60(D3) of the area D is emptied into the pipe section 122. This situation is presented in FIG. 2 and further clarified in FIG. 3. Compared to the previous operating mode, the valves of the input point 60(D3) now to be emptied have been opened, and the valves of the input point 60 that were open in connection with the previous emptying are closed. In addition, the valve 135 of the transfer pipe, which is between the pipe sections 119 and 110, is closed. In this case the suction effect of all three pump devices can be directed at exactly the correct pipe section 118-120-121, on the one hand, and at the same time it is ensured that the flow is not able to occur past the pipe section in question, e.g. via the pipe section 119. The contents of the feed-in container of the input point 60(D3) transfer to the pipe section 122 of the transfer pipe and when the replacement air valve 136 (FIG. 3a) of the pipe section 122 is opened, when the valves of the input points 60 are closed, in which case the pressure difference transfers the waste material in the transfer pipe onwards from there via the pipe section 121-120-118-110-106-103b to the separating means 20b. The valve 130 in the section 116 and the valve 131 in the section 116 are open. Likewise the valve 133 in the section 118 is open. The pressure difference and/or the conveying air current achieved transfers the material from the feed-in container into the transfer pipe into the section 122 and onwards to the pipe section 121 and onwards along the aforementioned route to the separating means.

From the operating modes presented above it can be seen that the operation of the system is controlled such that for the emptying of the input points of the desired operating area at least one valve that is in the transfer direction of the material with respect to the operational area of the transfer pipe and that is on the output side, i.e. on the suction side, of the conveying air is open, in which case the suction is able to act in the transfer pipe of the operational area.

Typically the input points 60 of the operating area, or at least a part of them, are emptied such that the contact of input point that is closest to the delivery end in the travel direction of the transfer pipe, i.e. closest to the separating device 20b in the embodiment according to the figure, to the transfer pipe is opened first, in which case the material is able to transfer from the first input point into the transfer pipe. After this the connection of the next input point to the transfer pipe is opened, and the connection of the first input point, which is already emptied, is closed.

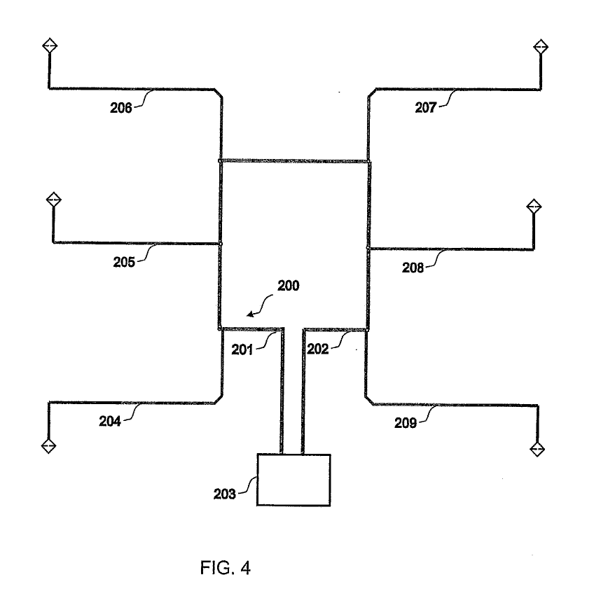

FIG. 4 further presents a simplified diagram of a system according to the invention. In the center of the figure is a part of the circuit in which conveying air can be circulated. The pipe sections 204, 205, 206, 207, 208, 209, in which conveying air is not circulated, are joined at their first ends to the pipe sections 201, 202 of the circuit. The second end of these typically comprises a replacement air valve, which is opened and closed according to need. The input points of the pipe sections 204, 205, 206, 207, 208, 209 are not presented in the figure, but instead the purpose of the figure is to illustrate a preferred method to utilize the solution according to the invention in large materials moving systems, such as in pneumatic systems for moving wastes. Each of the pipe sections 204, 205, 206, 207, 208, 209, which can be connected at their second end to the circuit 201, 202 can comprise one or more input points, as does the pipe section 122 presented in FIGS. 1-3. The pump devices and separating means, and other such drive devices, of the system are shown in the diagram with the marking 203. As described earlier, the circulation of the conveying air in the circuit can be changed, in which case both of the pipe sections 201, 202 can function, depending on the situation, as an output pipe or as a return pipe.

The invention thus relates to a method in a pneumatic materials moving system, such as a waste transfer system, which transfer system comprises at least one input point 60 of material, more particularly of waste material, a material transfer pipe 100, which pipe can be connected to the input point 60, and at least one separating device 20a, 20b, in which the material to be conveyed is separated from the conveying air, and means for achieving a pressure difference and/or a conveying air current in the transfer pipe 100 at least during conveyance of the material, which means for achieving a pressure difference and/or a conveying air current comprise at least one pump unit, which comprises at least one pump device 51a, 51b, 51c, 51d. In the method the transfer piping 100 comprises at least one transfer pipe section, in which conveying air is circulated, and at least one transfer pipe section 122; 204, 205, 206, 207, 208, 209, in which conveying air is not circulated, which section can be connected to that part of the transfer piping in which conveying air is circulated, at least during the emptying of the input point of the transfer pipe section and during the conveyance of material in the transfer pipe section 122; 204, 205, 206, 207, 208, 209 such that the conveying route of the material in the transfer piping is formed partly from the transfer pipe section 122; 204, 205, 206, 207, 208, 209 in which conveying air is not circulated, and partly from the transfer pipe section in which conveying air is circulated, and that the transfer pipe section 122; 204, 205, 206, 207, 208, 209 in which conveying air is not circulated is formed to be smaller in its diameter than the transfer pipe section in which conveying air is circulated.

According to one preferred embodiment in the method the pressure side and/or the suction side of at least one pump device 51a, 51b, 51c, 51d can be connected to the transfer piping 100, at least a part of which forms a circuit in which conveying air can be circulated, and that the air volume to be blown out of the transfer piping 100 corresponds essentially to the air volume coming into the transfer piping.

According to one preferred embodiment in the method conveying air can be circulated in a circuit formed by at least a part of the transfer piping with a pump device 50a, 50b, 50c, the suction side of which is connected to at least one separating device 20a, 20b and onward to a transfer pipe 100, on its return side, such that, if necessary, at least a part of the conveying air on the pressure side of the pump devices is led into the circuit on the output side of the transfer pipe.

According to one preferred embodiment in the method the transfer system comprises at least one transfer pipe section in which conveying air is circulated, and at least one transfer pipe section 122; 204, 205, 206, 207, 208, 209 in which conveying air is not circulated, which section can be connected to that part of the system in which conveying air is circulated, of which the transfer pipe section 122; 204, 205, 206, 207, 208, 209 in which conveying air is not circulated is formed to be smaller in diameter than the transfer pipe section of the system in which conveying air is circulated.

According to one preferred embodiment in the method air is removed from the circuit via at least one air outlet 57a, 57b, 57c, 57d, which preferably comprises a closing means/adjustment means, such as a valve means 58a, 58b, 58c, 58d.

According to one preferred embodiment also the circulation of air in a circuit, which comprises at least a part of the transfer piping 100, is adjusted and/or controlled and/or opened or closed with closing means/adjustment means, such as with valve means 107, 108, 113, 114, 130, 131, 132, 133, 134, 135, which are arranged in the circuit.

According to one preferred embodiment in the method a partial vacuum is achieved in the circuit with at least one pump device 51a, 51b, 51c, 51d, such as a partial-vacuum generator and/or a fan, the suction side of which is connected to a separating means 20a, 20b or to a transfer pipe 100, 109, 110 leading to it via an air duct 101a, 101b.

According to one preferred embodiment in the method pressure is achieved in the circuit with at least one pump device 51a, 51b, 51c, 51d, such as a partial-vacuum generator and/or a fan, the blowing side of which is connected to blow into the circuit.

According to one preferred embodiment in the method the air circulation is adjusted by connecting it, if necessary, into the opposite direction in at least a part of the circuit, which part is formed from at least a part of a transfer pipe 100.

According to one preferred embodiment in the method material is fed in from the input points 60 of material, which are the input points of waste, such as waste receptacles or refuse chutes.

According to one preferred embodiment in the method replacement air is brought into the circuit via at least one replacement air duct, which preferably comprises a valve means, in which case the replacement air brought into the circuit essentially corresponds to the air volume blown out of the circuit.

According to one preferred embodiment in the method at least one valve means 62 is between an input point 60 and a transfer pipe 100, by opening and closing which valve means the input of material and/or replacement air into the transfer pipe is adjusted.

According to one preferred embodiment in the method the transfer pipe section 122; 204, 205, 206, 207, 208, 209 in which conveying air is not circulated is formed to be large in its length, in which case the length of the transfer pipe section is typically over 100 meters, even over 1000 meters, even a number of kilometers.

According to one preferred embodiment in the method pipes are used as the transfer piping 100, the diameter of which is typically in the range 100-1000 mm, preferably 300-800 mm, most preferably 450-600 mm.

According to one preferred embodiment the sum of the flow rate of the air flow acting in the transfer pipe section 122; 204, 205, 206, 207, 208, 209 of at least one transfer pipe section 122; 204, 205, 206, 207, 208, 209 in which conveying air is not circulated, which section can be connected to that part of the transfer piping in which conveying air is circulated, at least during the emptying of the input point of the transfer pipe section and during the conveyance of material, and the flow rate of the blowing air flow of the circuit corresponds to the flow rate of the air flow of the suction side of the circuit at least at the point of connection of the pipe section 122 to the circuit, or in the proximity of it.

The invention also relates to an apparatus in a pneumatic materials moving system, such as in a waste transfer system, which comprises at least one input point 60 of material, more particularly of waste material, a material transfer pipe 100, which can be connected to an input point 60, and a separating device 20a, 20b, in which the material to be conveyed is separated from the conveying air, and means 50a, 50b, 50c, 50d for achieving a pressure difference and/or a conveying air current. The transfer piping 100 comprises at least one transfer pipe section, which can be formed into a circuit in which conveying air can be circulated, and that there is at least one transfer pipe section 122 in which conveying air is not circulated, which section can be connected to that part of the transfer piping in which conveying air can be circulated, at least during the emptying of the input point 60 of the transfer pipe section and during the conveyance of material in the transfer pipe section 122, such that the conveying route of the material in the transfer piping 100 is fitted to be formed partly from a transfer pipe section 122 in which conveying air is not circulated, and partly from a transfer pipe section in which conveying air is circulated, and that the transfer pipe section 122 in which conveying air is not circulated is formed to be smaller in its diameter than the transfer pipe section in which conveying air is circulated.

According to one preferred embodiment the apparatus further comprises means for circulating the conveying air in a circuit formed by at least a part of the transfer piping with a pump device 50a, 50b, 50c, the suction side of which can be connected to at least one separating device 20a, 20b and onward to a transfer pipe 100, on its return side, such that, if necessary, at least a part of the conveying air on the pressure side of the pump devices can be led into the circuit on the output side of the transfer pipe.

According to one preferred embodiment the air volume to be blown out of the transfer piping is fitted to essentially correspond to the air volume coming into the transfer piping.

According to one preferred embodiment the apparatus comprises closing means/adjustment means, such as valve means 107, 108, 113, 114, 130, 131, 132, 133, 134, 135, arranged in a circuit, which comprises at least a part of the transfer piping, with which means also the circulation of conveying air can be adjusted and/or controlled and/or opened or closed.

According to one preferred embodiment at least one transfer pipe section 122; 204, 205, 206, 207, 208, 209 in which conveying air is not circulated can be connected to that part of the transfer piping in which conveying air is circulated, such that at least during the emptying of the input point of the transfer pipe section and during the conveyance of material, the sum of the flow rate of the air flow acting in the transfer pipe section 122; 204, 205, 206, 207, 208, 209 and the flow rate of the blowing air flow of the circuit is fitted to correspond to the flow rate of the air flow of the suction side of the circuit at least at the point of connection of the pipe section 122 to the circuit, or in the proximity of it.

Typically the apparatus comprises at least one transfer pipe section in which conveying air is circulated, and at least one transfer pipe section 122 in which conveying air is not circulated, which section can be connected to that part of the transfer piping in which conveying air is circulated, of which the transfer pipe section 122 in which conveying air is not circulated is formed to be smaller in diameter than the transfer pipe section in which conveying air is circulated.

According to one preferred embodiment the apparatus comprises at least one outlet 57a, 57b, 57c, 57d, which preferably comprises a closing means/adjustment means 58a, 58b, 58c, 58d, such as a valve means, for removing at least a part of the air from the circuit.

According to one preferred embodiment the means for achieving a pressure difference comprise at least one pump device 50a, 50b, 50c, 50d, such as a partial-vacuum generator and/or a fan, the suction side of which is connected to a separating means 20a, 20b or to a transfer pipe 100, 109, 110 leading to it via an air duct 101a, 101b.

According to one preferred embodiment the means for achieving a pressure difference comprise at least one pump device 51a, 51b, 51c, 51d, such as a partial-vacuum generator and/or a fan, and means 55a, 56a; 55b, 56b; 55c, 56c; 55d, 56d; 111, 112, 113, 114 for connecting the blowing side of at least one pump device, such as a partial-vacuum generator and/or a fan, to blow into the circuit.

According to one preferred embodiment the apparatus comprises means 107, 108, 111, 112, 113, 114 for connecting the conveying air circulation into the opposite direction in at least a part of the circuit, which part is formed from at least a part of a transfer pipe 100.

According to one preferred embodiment the input points 60 of material are the input points of waste, such as waste receptacles or refuse chutes.

According to one preferred embodiment at least one valve means 62 is between an input point 60 and a transfer pipe 100, by opening and closing which valve means the input of material and/or replacement air into the transfer pipe is adjusted.

According to one preferred embodiment the apparatus comprises at least one air inlet 66, which preferably comprises a valve means 64, for bringing air into the circuit from outside it.

According to one preferred embodiment the transfer pipe section 122; 204, 205, 206, 207, 208, 209 in which conveying air is not circulated is large in its length, in which case the length of the transfer pipe section is typically over 100 meters, even over 1000 meters, even a number of kilometers.

According to one preferred embodiment pipes are used as the transfer piping (100), the diameter (d) of which is typically in the range 100-1000 mm, preferably 300-800 mm, most preferably 450-600 mm.

Typically the suction produced in the transfer pipe by the pump devices, on the side of the separating device in the figure, is preferably larger than the blowing, in which case transfer occurs in a partial vacuum. When the suction is greater than the blowing, a partial vacuum is achieved in the piping, in which case waste can be sucked to inside the piping from the feed-in container of an input point.

The discharge valve of an input point is opened and closed such that material batches of a suitable size are transferred from the input point into the transfer pipe. Material is fed in from an input point, such as from a waste bin or refuse chute, and after it has filled a discharge valve is opened, either automatically or manually.

The system can also comprise a number of separating devices 20a, 20b, into which conveyance of material is guided e.g. according to the type of material or on the basis of the capacity of the system.

When using a system according to the embodiment of the invention, in which a system that utilizes the circulation of conveying air, i.e. a Ring Line system, and a transfer pipe section 122, in which conveying air is not circulated, i.e. a Single Line system, connected to it are combined, an advantageous pressure loss situation is achieved and up to 30-50% energy can be saved.

The pipe dimensioning of the transfer pipe section in which conveying air is not circulated, i.e. of the Single Line pipe section, is generally such that the loss of the pressure of the piping is calculated for the whole distance and the size of the piping is dimensioned according to the pressure loss. For long distances the diameter of the piping considerably increases, because the extractors/fans have a limited suction capability (partial-vacuum production capacity). As the diameter of the piping increases, the air volume needed increases considerably so that the waste would move in the piping. Typically the pipe size is e.g. 600 mm on a conveying distance of over 2 km and in this case the output power of the fans needed would be approx. 1000 kw.

If the Single Line and the Ring Line systems are connected, as in the cases of FIGS. 2 and 3, the Single Line pipe section 122 can be selected to be smaller, e.g. 450-500 mm, and the diameter of the Ring Line pipe section, i.e. the pipe section in which the conveying air can be circulated in the circuit, to be larger, in this case e.g. 600 m, in which case some of the air volume is sufficient to transfer wastes in the Single Line part of the piping to the Ring Line pipe section, i.e. to the pipe section that forms a circuit in which conveying air can be circulated. In this case typically the speed of the conveying air is also greater. The total power requirement is in this case approx. 500 kw, i.e. the saving is approx. 50%. Typically the saving is in the range of 30-50%. Typically, therefore, the sum of the flow rate of the air flow acting in the transfer pipe section 122; 204, 205, 206, 207, 208, 209 of at least one transfer pipe section 122; 204, 205, 206, 207, 208, 209 in which conveying air is not circulated, which section can be connected to that part of the transfer piping in which conveying air is circulated, at least during the emptying of the input point of the transfer pipe section and during the conveyance of material, and the flow rate of the blowing air flow of the circuit corresponds to the flow rate of the air flow of the suction side of the circuit at least at the point of connection of the pipe section 122 to the circuit, or in the proximity of it.

It is obvious to the person skilled in the art that the invention is not limited to the embodiments presented above, but that it can be varied within the scope of the claims presented below. The characteristic features possibly presented in the description in conjunction with other characteristic features can also, if necessary, be used separately to each other.

1. Method in a pneumatic materials moving system, such as a waste transfer system, which transfer system comprises at least one input point of material, more particularly of waste material, a material transfer pipe, which can be connected to an input point, and at least one separating device, in which the material to be conveyed is separated from the conveying air, and means for achieving a pressure difference and/or a conveying air current in the transfer pipe at least during conveyance of the material, which means for achieving a pressure difference and/or a conveying air current comprise at least one pump unit, which comprises at least one pump device, wherein in the method the transfer piping comprises at least one transfer pipe section in which conveying air is circulated, and at least one transfer pipe section in which conveying air is not circulated, which section can be connected to that part of the transfer piping in which conveying air is circulated, at least during the emptying of an input point of the transfer pipe section and during conveyance of the material in the transfer pipe section, such that the conveying route of the material in the transfer piping is formed partly from a transfer pipe section in which conveying air is not circulated, and partly from a transfer pipe section in which conveying air is circulated, and in that the transfer pipe section in which conveying air is not circulated is formed to be smaller in its diameter than the transfer pipe section in which conveying air is circulated.

2. Method according to claim 1, wherein in the method the pressure side and/or the suction side of at least one pump device can be connected to the transfer piping, at least a part of which fauns a circuit in which conveying air can be circulated, and in that the air volume to be blown out of the transfer piping corresponds essentially to the air volume coming into the transfer piping.

3. Method according to claim 1, wherein in the method conveying air can be circulated in a circuit formed by at least a part of the transfer piping with a pump device, the suction side of which is connected to at least one separating device and onward to a transfer pipe, on its return side, such that, if necessary, at least a part of the conveying air on the pressure side of the pump devices is led into the circuit on the output side of the transfer pipe.

4. Method according to claim 1 wherein in the method air is removed from the circuit via at least one air outlet, which preferably comprises a closing means/adjustment means, such as a valve means.

5. Method according to claim 1, wherein also the circulation of air in a circuit, which comprises at least a part of the transfer piping, is adjusted and/or controlled and/or opened or closed with closing means/adjustment means, such as with valve means, which are arranged in a circuit.

6. Method according to claim 1, wherein in the method a partial vacuum is achieved in the circuit with at least one pump device, such as a partial-vacuum generator and/or a fan, the suction side of which is connected to a separating means or to a transfer pipe leading to it via an air duct.

7. Method according to claim 1, wherein in the method pressure is achieved in the circuit with at least one pump device, such as a partial-vacuum generator and/or a fan, the blowing side of which is connected to blow into the circuit.

8. Method according to claim 1, wherein in the method the air circulation is adjusted by connecting it, if necessary, into the opposite direction in at least a part of the circuit, which part is formed from at least a part of a transfer pipe.

9. Method according to claim 1, wherein in the method material is fed in from the input points of material, which are the input points of waste, such as waste receptacles or refuse chutes.

10. Method according to claim 1, wherein in the method replacement air is brought into the circuit via at least one replacement air duct, which preferably comprises a valve means, in which case the replacement air brought into the circuit essentially corresponds to the air volume blown out of the circuit.

11. Method according to claim 1, wherein at least one valve means is between an input point of material and a transfer pipe, by opening and closing which valve means the input of material and/or replacement air into the transfer pipe is adjusted.

12. Method according to claim 1, wherein the transfer pipe section in which conveying air is not circulated is formed to be large in its length, in which case the length of the transfer pipe section is typically over 100 meters, even over 1000 meters, even a number of kilometers.

13. Method according to claim 1, wherein pipes are used as the transfer piping, the diameter of which is typically in the range 100-1000 mm, preferably 300-800 mm, most preferably 450-600 mm.

14. Method according to claim 1, wherein the sum of the flow rate of the air flow acting in the transfer pipe section of at least one transfer pipe section in which conveying air is not circulated, which section can be connected to that part of the transfer piping in which conveying air is circulated, at least during the emptying of the input point of the transfer pipe section and during the conveyance of material, and the flow rate of the blowing air flow of the circuit corresponds to the flow rate of the air flow of the suction side of the circuit at least at the point of connection of the pipe section to the circuit, or in the proximity of it.

15. Apparatus in a pneumatic materials moving system, such as a waste transfer system, which comprises at least one input point of material, more particularly of waste material, a material transfer pipe, which can be connected to an input point, and a separating device, in which the material to be conveyed is separated from the conveying air, and means for achieving a pressure difference and/or a conveying air current, wherein the transfer piping comprises at least one transfer pipe section, which can be formed into a circuit in which conveying air can be circulated, and in that there is at least one transfer pipe section in which conveying air is not circulated, which section can be connected to that part of the transfer piping in which conveying air can be circulated, at least during the emptying of an input point of the transfer pipe section and during conveyance of the material in the transfer pipe section, such that the conveying route of the material in the transfer piping is fitted to be formed partly from a transfer pipe section in which conveying air is not circulated, and partly from a transfer pipe section in which conveying air is circulated, and in that the transfer pipe section in which conveying air is not circulated is formed to be smaller in its diameter than the transfer pipe section in which conveying air is circulated.

16. Apparatus according to claim 15, wherein the apparatus further comprises means for circulating conveying air in a circuit formed by at least a part of the transfer piping with at least one pump device, the suction side of which can be connected to at least one separating device and onward to a transfer pipe, on its return side, such that, if necessary, at least a part of the conveying air on the pressure side of the pump devices can be led to the output side of the transfer pipe into the circuit.

17. Apparatus according to claim 15, wherein the air volume to be blown out of the transfer piping is fitted to essentially correspond to the air volume coming into the transfer piping.

18. Apparatus according to claim 15, wherein the apparatus comprises closing means/adjustment means, such as valve means, arranged in a circuit, which comprises at least a part of the transfer piping, with which means also the circulation of conveying air can be adjusted and/or controlled and/or opened or closed.

19. Apparatus according to claim 15 wherein at least one transfer pipe section in which conveying air is not circulated can be connected to that part of the transfer piping in which conveying air is circulated such that at least during emptying of the input point of the transfer pipe section and conveyance of the material, the sum of the flow rate of the air flow acting in the transfer pipe section and the flow rate of the blowing air flow of the circuit is fitted to correspond to the flow rate of the air flow of the suction side of the circuit at least at the point of connection of the pipe section to the circuit, or in the proximity of it.

20. Apparatus according to claim 15, wherein the apparatus comprises at least one outlet, which preferably comprises a closing means/adjustment means, such as a valve means, for removing at least a part of the air from the circuit.

21. Apparatus according to claim 15, wherein the means for achieving a pressure difference comprise at least one pump device, such as a partial-vacuum generator and/or a fan, the suction side of which is connected to a separating means or to a transfer pipe leading to it via an air duct.

22. Apparatus according to claim 15, wherein the means for achieving a pressure difference comprise at least one pump device, such as a partial-vacuum generator and/or a fan, and means for connecting the blowing side of at least one pump device, such as a partial-vacuum generator and/or a fan, to blow into the circuit.

23. Apparatus according to claim 15, wherein the apparatus comprises means for connecting the conveying air circulation into the opposite direction in at least a part of the circuit, which part is formed from at least a part of a transfer pipe.

24. Apparatus according to claim 15, wherein the input points of material are the input points of waste, such as waste receptacles or refuse chutes.

25. Apparatus according to claim 15, wherein at least one valve means is between an input point and a transfer pipe, by opening and closing which valve means the input of material and/or replacement air into the transfer pipe is adjusted.

26. Apparatus according to claim 15, wherein the apparatus comprises at least one air inlet, which preferably comprises a valve means, for bringing air into the circuit from outside it.

27. Apparatus according to claim 15, wherein the transfer pipe section in which conveying air is not circulated is large in its length, in which case the length of the transfer pipe section is typically over 100 meters, even over 1000 meters, even a number of kilometers.

28. Apparatus according to claim 15, wherein pipes are used as the transfer piping, the diameter of which is typically in the range 100-1000 mm, preferably 300-800 mm, most preferably 450-600 mm.
